(19) United States
(12) Patent Application Publication
(10) Pub. No.: US 2004/0201303 A1
(43) Pub. Date: Oct. 14, 2004

(54) Armature of electric rotating machine, electric rotating machine using the same and manufacturing method for armature of electric rotating machine

(75) Inventors: Dongning Zhang, Nagano (JP); Noboru Ootsuki, Nagano (JP)

Correspondence Address: HOGAN & HARTSON L.L.P., 500 S. GRAND AVENUE, SUITE 1900, LOS ANGELES, CA, 90071-2611, US

(73) Assignee: SANKYO SEIKI MFG. CO., LTD.

(21) Appl. No.: 10/763,050

(22) Filed: Jan. 21, 2004

(30) Foreign Application Priority Data
Feb. 3, 2003 (JP) 2003-025503
Jul. 22, 2003 (JP) 2003-277906

(51) Int. Cl. H02K 1/00; H02K 3/00

(52) U.S. Cl. 310/216; 310/179

(57) ABSTRACT

An armature of an electric rotating machine includes an armature core provided with plural divided cores arranged in a circumferential direction. A salient pole is provided in each of the plural divided cores. A coil winding is wound around each salient pole. A convex winding configuration of the coil winding is formed so as to project on an adjacent salient pole side over a boundary line between adjacent divided cores. A concave winding configuration of the coil winding is formed so as to be hollow from the boundary line so as not to interfere with the convex winding configuration.

### BACKGROUND OF THE INVENTION

1. Field of the Invention

The present invention relates to an armature of an electric rotating machine in which a plurality of salient poles are arranged in a circumferential direction by combining a plurality of divided cores, and an electric rotating machine using the armature and a manufacturing method for the armature of an electric rotating machine.

2. Description of Related Art

Various proposals are conventionally known in which an armature core used in an electric rotating machine such as a motor is constituted of divided cores. The divided core structure is adopted to enhance the space factor of winding to reduce the copper loss or the like, which leads to the improvement of rotational characteristics and miniaturization. For example, as shown in FIG. 9, the entire armature core 1 is constituted of an annular assembled body formed by divided cores 2, which are divided into plural pieces along a circumferential direction. When the plural divided cores 2 are to be fixed, two arc-shaped core segments 3 disposed on an outer peripheral side in the respective divided cores are brought into contact with each other so as to abut in the circumferential direction and fixed on a frame by a clamping force of a screw not shown in the drawing.

Then, when coil windings 4 are applied to the armature having a constitution in such a divided core structure, core winding assemblies are individually manufactured for every divided core 2. For example, each of the core winding assemblies is constituted in such a manner that, after an insulating layer made of resin is formed on every divided core 2, a coil winding 4 to be wound concentrated is applied to an arm part 5 of a salient pole provided in the respective divided cores 2, particularly as shown in FIG. 10. When the armature having such a divided core structure is employed, a thicker coil is capable of being wound with more number of turns and a so-called space factor of the coil winding can be easily enhanced.

Alternatively, in order that the coil winding 4 is formed on the divided core 2, a plurality of divided cores 2 are arranged in a developed and connected state along a certain direction to enlarge the respective spaces between the arm parts 5 of the respective salient poles, and the coil winding 4 is formed on the arm part 5 of the respective salient poles.

However, in the conventional armature constituted in such a divided core structure, the space factor of the coil winding 4 is not yet sufficient. For example, generally in the armature constituted in the divided core structure, the adjacent coil windings 4 of the divided cores 2 in a circumferential direction are required to be disposed not to interfere with each other when the plural divided cores 2 are assembled. Therefore, in the above-mentioned conventional armature constituted in the divided core structure, for example, as shown in FIG. 11, all coil windings 4 fitted to the divided cores 2 are formed so as not to project over the boundary line X defined by the adjacent coil winding 4 which is wound around the other divided core 2 in order to ensure assembling of the divided cores. In other words, in the conventional divided core structure, the wound configuration of all the coil windings 4 is formed in a concaved shape with respect to the boundary line X.

However, as described above, when all the coil windings 4 are formed in the hollow and concaved shape which does not exceed the boundary line X of an adjacent coil winding 4, useless spaces are formed between the adjacent coil windings 4 fitted on the divided cores 2. Therefore, the space factor of the coil winding is not sufficient and characteristics such as a torque constant are not satisfactory.

### SUMMARY OF THE INVENTION

In view of the problems described above, it is an advantage of the present invention to provide an armature of an electric rotating machine in which the space factor of a coil winding in a divided core structure is improved, and an electric rotating machine using the armature and a manufacturing method for the armature of an electric rotating machine.

In order to achieve the above advantage, according to the present invention, there is provided an armature of an electric rotating machine including an armature core which includes plural divided cores arranged in a circumferential direction, a salient pole which is provided in the divided core, a coil winding which is wound around the salient pole, a convex winding configuration of the coil winding which is formed so as to project on an adjacent salient pole side over a boundary line between the divided core and an adjacent divided core of the plural divided cores, and a concave winding configuration of the coil winding which is formed to be hollow from the boundary line so as not to interfere with the convex winding configuration.

In accordance with an embodiment of the present invention, a boundary line X is supposedly located between a pair of divided cores which are adjacent to each other in a circumferential direction. The boundary line X extends to both circumferential end positions of the divided core which are respectively located at an equal angle from the center line C of an arm part of the salient pole on both sides in the circumferential direction. The angle of the boundary line X with respect to the center line C is set to be half (θ/2) of the center open angle θ, which is defined by the center lines C of the two arm parts. The coil winding provided on one of the pair of divided cores is formed in a convex winding configuration, which projects on the other divided core side over the boundary line X and the coil winding wound around the other divided core is formed in a concave winding configuration, which is hollow from the boundary line X, so as not to interfere with the convex winding configuration.

According to the armature of an electric rotating machine having such a constitution, the respective coil windings of the divided cores adjacent to each other in the circumferential direction can be formed or wound without useless space that occurs when the coil windings are formed or wound so as not to project over the boundary line X as the conventional constitution. Therefore, the space factor of the coil winding is enhanced by the amount of the useless space that occurs when the coil windings are formed or wound so as not to project over the boundary line X.

In accordance with an embodiment of the present invention, the plural divided cores are constituted in a separated structure in which the divided core is divided by every salient pole in the circumferential direction. According to the armature of an electric rotating machine having such a constitution, the coil winding is formed or wound individually around each salient pole provided for every divided core, and thus a coil winding operation is efficiently performed.

In accordance with an embodiment of the present invention, the divided core is constituted of a laminated core which is formed of magnetic plates laminated in a thickness direction and the boundary line X between the divided cores extends along the abutting surfaces of the divided cores. According to the armature of an electric rotating machine having such a constitution, the boundary line X of the divided cores in the circumferential direction is clarified, and thus the winding operation for the coil winding is performed easily and precisely.

In accordance with an embodiment of the present invention, the coil winding is formed into two types of winding configurations which are alternately different from each other for every adjacent divided core in the circumferential direction. According to the armature of an electric rotating machine having such a constitution, only two types of winding configurations of the coil winding are required. Thus, manufacturing or managing of the coil winding is easily performed.

In accordance with an embodiment of the present invention, the coil windings are set to have the same number of turns for every divided core. According to the armature of an electric rotating machine having such a constitution, even though the winding configurations of the coil windings are different from each other, the exciting balance of the coil windings by electric current is satisfactorily maintained and the winding operation is facilitated.

In accordance with an embodiment of the present invention, the number of turns of the coil winding is set to be in an alternately different number of turns for every adjacent divided core. According to the armature of an electric rotating machine having such a constitution, as far as within the range of permitted characteristics, the coil winding can be formed or wound more densely so as to cope with the space shape between the adjacent divided cores, and thus the space factor of the coil winding can be further improved.

Further, in order to achieve the above advantage, according to the present invention, there is provided an electric rotating machine provided with the above-mentioned armature. According to the electric rotating machine having such a constitution, the effects based on the above-mentioned armature are satisfactorily obtained in a similar manner.

Furthermore, in order to achieve the above advantage, according to the present invention, there is provided a manufacturing method for an armature of an electric rotating machine including providing an armature core which includes plural divided cores each of which is provided with a salient pole, winding a coil wire around the salient pole of the divided core so as to form a convex winding configuration which is formed to project over a boundary line to an adjacent divided core, and winding a coil wire around the salient pole of the adjacent divided core so as to form a concave winding configuration which is formed to be hollow from the boundary line so as not to interfere with the convex winding configuration.

According to the manufacturing method for the armature of an electric rotating machine described above, the respective coil windings of the divided cores adjacent to each other in the circumferential direction can be formed or wound without the useless space that occurs when the coil windings are formed or wound so as not to project over the boundary line X. Therefore, the space factor of the coil winding is enhanced by the amount of the useless space that occurs when the coil windings are formed or wound so as not to project over the boundary line X.

As described above, the armature of an electric rotating machine in accordance with the present invention includes a coil winding wound around the salient pole which has a convex winding configuration formed so as to project over the boundary line between the divided cores, and a coil winding which has a concave winding configuration which is hollow from the boundary line so as not to interfere with the convex winding configuration. Therefore, the space factor of the coil winding is enhanced, and thus rotational characteristics such as the torque constant are improved without the size of the electric rotating machine becoming larger.

In addition, the manufacturing method for the armature of an electric rotating machine in accordance with the present invention includes winding a coil wire around the salient pole of the divided core so as to form a convex winding configuration which is formed to project over the boundary line between the divided cores, and winding a coil wire around the salient pole of the adjacent divided core so as to form a concave winding configuration which is formed to be hollow from the boundary line so as not to interfere with the convex winding configuration. Therefore, the space factor of the coil winding is enhanced, and thus rotational characteristics such as the torque constant are improved without the size of the electric rotating machine becoming larger.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is an explanatory plan view showing an armature of an inner rotor type motor in accordance with an embodiment of the present invention.

FIG. 2 is an explanatory enlarged plan view showing an abutting portion of a pair of divided cores constituting the armature shown in FIG. 1.

FIGS. 3(a) and 3(b) are explanatory plan views showing two types of divided cores constituting the armature shown in FIG. 1.

FIG. 4 is an explanatory plan view showing an armature of an inner rotor type motor in another embodiment of the present invention.

FIGS. 5(a) and 5(b) are explanatory plan views showing two types of divided cores constituting the armature shown in FIG. 4.

FIG. 6 is an explanatory enlarged plan view showing a boundary portion between a rib shaped arm part and a teeth shaped magnetism collecting part of the divided core shown in FIGS. 4, 5(a) and 5(b).

FIG. 7 is an explanatory enlarged plan view showing an abutting portion of a pair of divided cores constituting an armature in further another embodiment of the present invention.

FIG. 8 is an explanatory enlarged plan view showing an abutting portion of a pair of divided cores constituting an armature in further another embodiment of the present invention.

FIG. 9 is an explanatory plan view showing an armature of a conventional inner rotor type motor.

FIG. 10 is an explanatory exploded view showing divided cores constituting the armature shown in FIG. 9.

FIG. 11 is an explanatory enlarged plan view showing an abutting portion of a pair of divided cores constituting the armature shown in FIG. 9.

### DETAILED DESCRIPTION OF THE PREFERRED EMBODIMENTS

An armature of a motor in accordance with an embodiment of the present invention will be described below in detail with reference to the accompanying drawings.

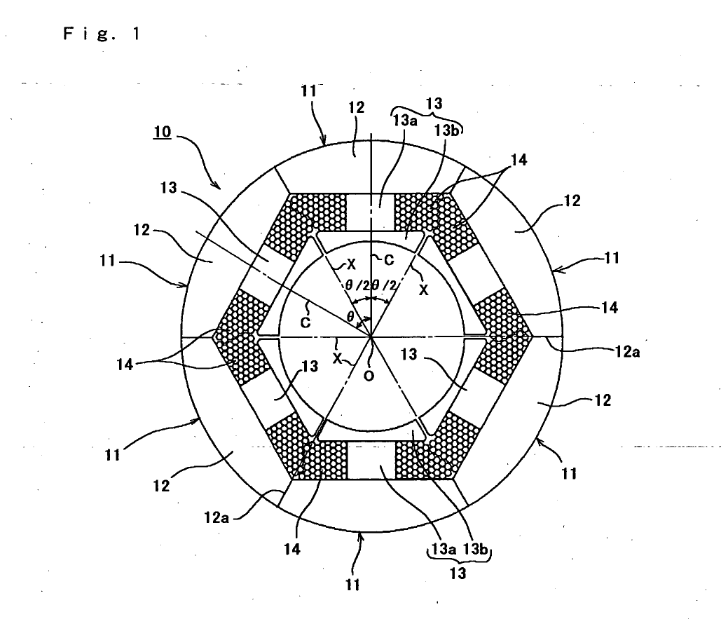

An armature 10 for an inner rotor type motor shown in FIG. 1 is constituted such that six divided cores 11 which are divided by every respective pole are assembled to form an annular shape. The respective divided cores 11 are formed from a laminated core constituted of magnetic plates laminated in a thickness direction. Each of the divided cores 11 is provided with an arc-shaped core segment 12 which is formed by dividing an annular ring-shaped core into six segments in a circumferential direction and a salient pole 13 which protrudes radially towards a core center from the arc-shaped core segment 12.

Both end surfaces of the respective arc-shaped core segments 12 in the circumferential direction are formed as abutting surfaces 12a which are formed to be flat faced extending radially. The abutting surfaces 12a of the two arc-shaped core segments 12 which are adjacent to each other in the circumferential direction are brought into tight contact with each other by abutting against each other in the circumferential direction.

The salient pole 13 is provided with a rib shaped arm part 13a, which extends on an inner side radially from the approximately central portion of the inner peripheral surface in a radial direction of the arc-shaped core segment 12. In other words, the respective rib shaped arm parts 13a are formed so as to extend radially along the respective center lines C, which are formed to have an approximately equal central open angle θ from an armature core center O when the above-mentioned six divided cores 11 are assembled in an annular shape. A teeth shaped magnetism collecting part 13b is respectively formed at the inner end portion of the rib shaped arm part 13a so as to protrude toward the core center O. The teeth shaped magnetism collecting part 13b is formed so as to project from both sides of the rib shaped arm part 13a towards the circumferential direction. The inner peripheral surface in the radial direction of the respective teeth shaped magnetism collecting parts 13b is formed in an approximately arc shape and disposed in close relation to the outer surface of a rotor part not shown in the drawing.

An appropriate insulation member is attached on the rib shaped arm part 13a of the respective salient poles 13, and a coil winding 14 is formed with a concentrated winding in such a manner that a coil wire is aligned into a plurality of rows or stages through the insulation member.

A boundary line X is supposedly located between a pair of divided cores 11 which are adjacent to each other in a circumferential direction. Each of the respective boundary lines X in the present embodiment of the present invention extends radially along the abutting surfaces 12a, which are formed on both end surfaces of the arc shaped core segment 12 in the circumferential direction. In other words, the respective boundary lines X extend to both circumferential end positions which are respectively located at an equal angle from the center line C of the arm part 13a of the salient pole 13 on both sides in the circumferential direction. The angle of the boundary line X with respect to the center line C is set to be half (θ/2) of the center open angle θ, which is defined between the center lines C of the two arm parts 13a.

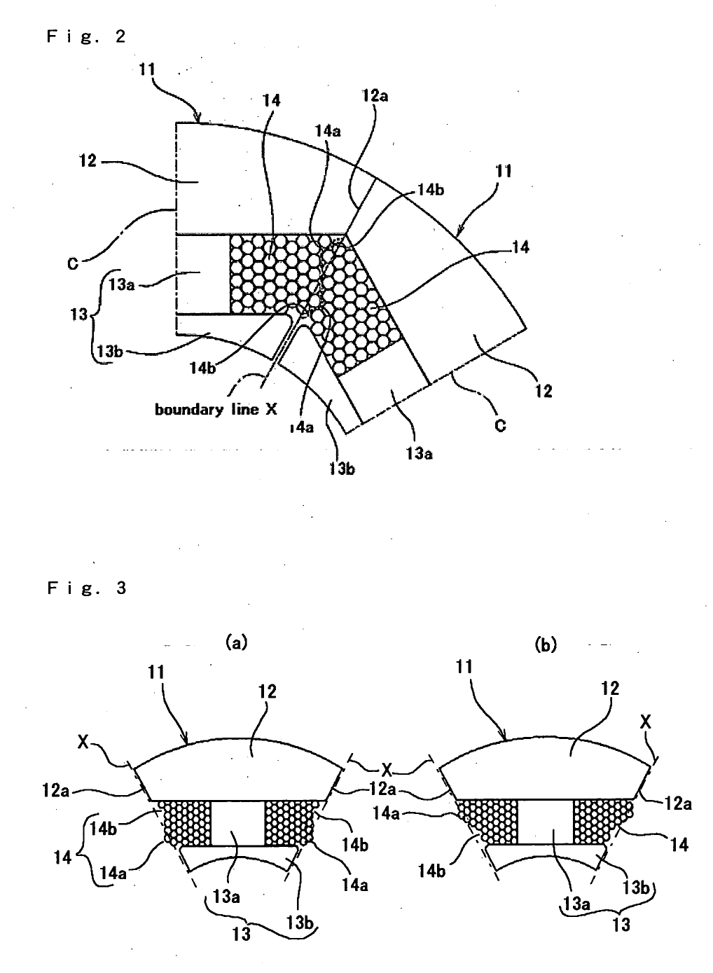

The coil winding 14 provided on one of a pair of divided cores 11 adjacent to each other in the circumferential direction is formed, as especially shown in FIG. 2, in such a manner that an outer portion in the radial direction of the coil winding 14 is formed in a convex winding configuration 14a which projects on the other divided core 11 side over the boundary line X. On the other hand, an outer portion in the radial direction of the coil winding 14 wound around the other divided core 11 which is adjacent to the above-mentioned one of the divided core 11 is formed in a concave winding configuration 14b which is hollow from the boundary line X, so as not to interfere with the convex winding configuration 14a of the coil winding 14 wound around the above-mentioned one of the divided core 11. Also, an inner portion in the radial direction of the coil winding 14, which is formed such that the outer portion in the radial direction is formed to be the concave winding configuration 14b, is formed in a convex winding configuration 14a, which projects on the one of the divided cores 11 side over the boundary line X. On the other hand, an inner portion in the radial direction of the coil winding 14 formed in the convex winding configuration 14a at the outer portion is formed in a concave winding configuration 14b which is hollow from the boundary line X so as not to interfere with the convex winding configuration 14a of the coil winding 14 wound around the other of the divided core 11.

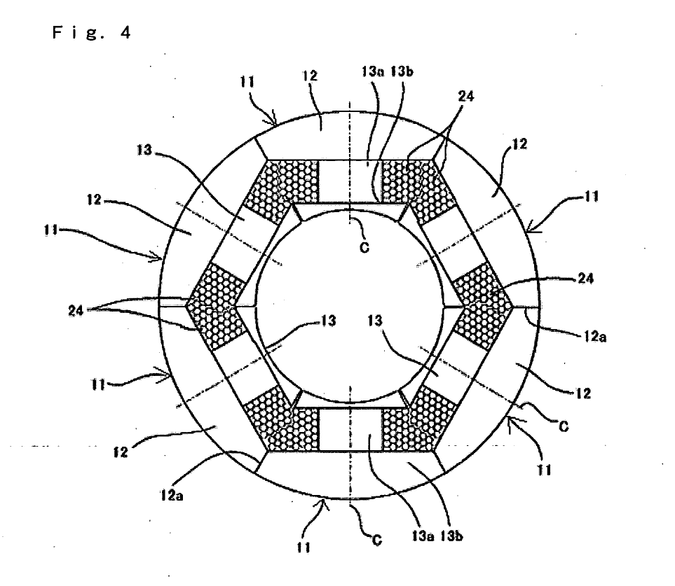

In other words, the divided core 11 according to the present embodiment is formed into two types of winding configurations. One type of divided core 11 is formed such that the convex winding configuration 14a of the coil winding 14 is on the inner peripheral side and the concave winding configuration 14b is on the outer peripheral side as shown in FIG. 3(a). The other type of divided core 11 is formed such that the convex winding configuration 14a of the coil winding 14 is on the outer peripheral side and the concave winding configuration 14b is on the inner peripheral side as shown in FIG. 3(b).

These two types of coil windings 14 in which the winding configurations are different from each other are alternately disposed in three pairs along the circumferential direction. The convex winding configuration 14a of one of the two types of the coil windings 14 and the concave winding configuration 14b of the other of the two types of coil windings 14 are disposed in such a manner that a gap space between the pair of adjacent divided cores 11 is substantially occupied by the two types of coil windings 14 without waste. Therefore, the space factor of the coil winding 14 is improved.

The two types of coil windings 14 in the present embodiment are set to each have the same number of turns and every divided core 11 is provided with a coil winding 14 having, for example, 45 turns. By employing the constitution having the same number of turns of the coil windings, even though the winding configurations of the coil windings 14 are different from each other, the exciting balance to the coil windings by electric current is satisfactorily maintained and the winding operation is facilitated.

Alternatively, as far as within the range of permitted characteristics, the number of turns of the coil winding 14 may be set in the different number of turns for every alternately adjacent divided core 11. According to the constitution that the number of turns is set to be different from each other, the coil winding 14 can be formed or wound more densely so as to cope with the space shape between the adjacent divided cores 11, and thus the space factor of the coil winding 14 may be expected to be furthermore improved.

According to the present embodiment as described above, the respective coil windings 14 of the divided cores 11 adjacent to each other in the circumferential direction are formed or wound within the useless space that occurs when the coil windings are formed or wound so as not to project over the boundary line X as the conventional coil windings. Therefore, the space factor of the coil winding 14 is enhanced by that amount of the useless space, and thus rotational characteristics such as the torque constant are improved without making the motor size larger.

In the present embodiment of the present invention, the boundary line X of the adjacent divided cores 11 in the circumferential direction extends along and passes on the abutting surfaces 12a of the respective divided cores 11. Therefore, the boundary line X of the adjacent divided cores 11 in the circumferential direction, which is supposedly determined, becomes clarified, and thus the winding operation for the coil winding 14 is performed easily and precisely.

Further, in the present embodiment of the present invention, the coil winding 14 has two different types of the winding configurations, which are alternately disposed every adjacent divided core 11 in the circumferential direction. Therefore, only two types of winding configurations of the coil winding 14 are required, and thus manufacturing or managing the coil winding 14 is easily performed.

Next, an armature in accordance with another embodiment of the present invention shown in FIG. 4, where the constituent element corresponding to the above-mentioned embodiment is indicated by the same notational symbol, is constituted in such a manner that two different types of winding configurations of the coil winding 24 are alternately disposed along the circumferential direction.

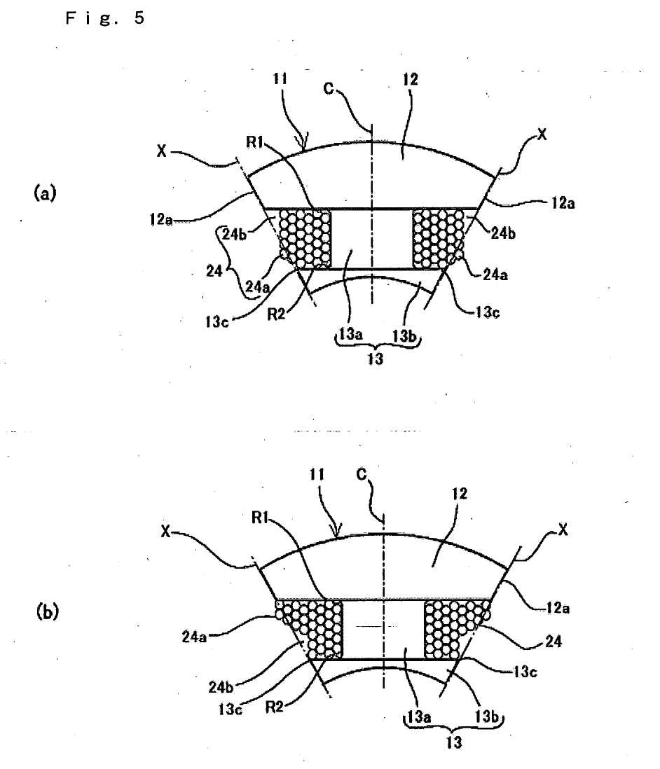

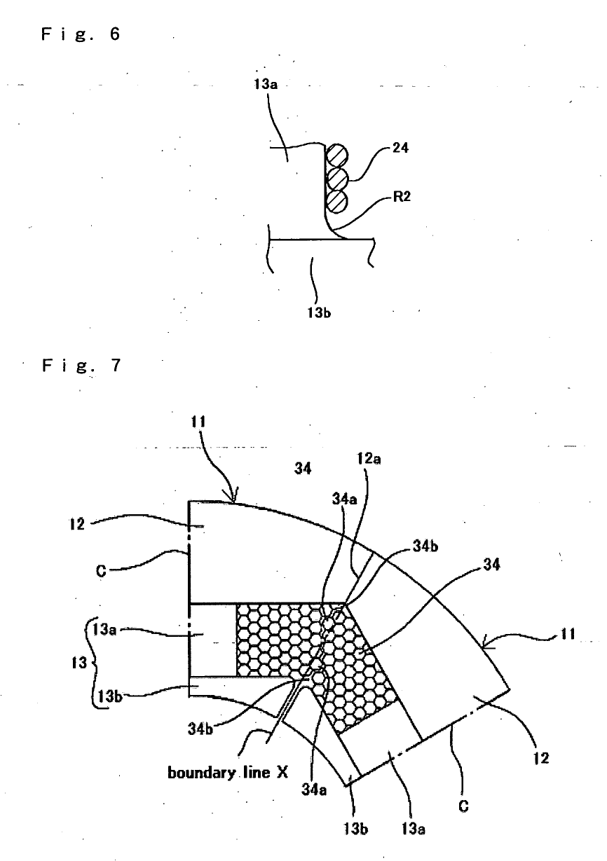

The two different types of winding configurations of the coil winding 24 are formed as follows. In other words, one type of the winding configuration on the divided core 11 is formed such that the convex winding configuration 24a of the coil winding 24, which projects on the other divided core side over the boundary line X, is on the inner peripheral side and the concave winding configuration 24b, which is hollow from the boundary line X so as not to interfere with the convex winding configuration, is on the outer peripheral side as shown in FIG. 5(a). The other type of divided core 11 is formed such that the convex winding configuration 24a of the coil winding 24 is on the outer peripheral side and the concave winding configuration 24b is on the inner peripheral side as shown in FIG. 5(b). The convex winding configuration 24a of one of the two types of coil windings 24 and the concave winding configuration 24b of the other of the two types of coil windings 24 are disposed in such a manner that the gap space between the pair of adjacent divided cores 11 is substantially occupied by the two types of coil windings 24 without waste. Therefore, the space factor of the coil winding 24 is improved.

Further, in the embodiment of the present invention, the number of the respective winding layers (rows or stages) in the above-mentioned coil winding 24, in other words, the total number of the winding layers of the coil winding 24, which is wound on the rib shaped arm part 13a of the respective salient poles 13, is set to be an “even number”. For example, the total number of the winding layers (vertical direction in the drawing) of the coil winding 24 shown in FIG. 5(a) is set to be six (6) and the total number of the winding layers of the coil winding 24 shown in FIG. 5(b) is set to eight (8).

Therefore, by means of the constitution having an “even number” of the winding layers of the coil winding 24, the winding start point and the winding end point of the coil winding 24 are positioned on the same side in a longitudinal direction of the rib shaped arm part 13a (radial direction). Accordingly, the winding operation for the coil winding 24 can be performed on the same side of the divided core 11 and thus an easy and reliable winding operation is assured.

In the embodiment of the present invention, the number of turns in the respective winding layers or rows of the above-mentioned coil winding 24 is set to be (N−1) turns in the odd layer including the first layer (innermost side) and set to be (N) turns in the even layer including the second layer. According to the setting of the number of turns of the coil in the respective winding layers, the winding is performed without generating a useless space over the entire winding layers of the coil winding.

In this case, the first winding layer (innermost layer) of the coil winding 24 which is wound around the rib shaped arm part 13a of the salient pole 13 is set to have (N−1) turns. Therefore, both end portions of the rib shaped arm part 13a in the longitudinal direction (radial direction), that is, the respective connecting portions of the rib shaped arm part 13a with the previously described arc shaped core segment 12 and the teeth shaped magnetism collecting part 13b, are provided with spaces corresponding to the width of one turn of the coil wire. Further, as shown in FIGS. 5(a), 5(b) and 6, by using the space corresponding to the width of one turn of the coil wire, the respective connecting portions can be formed with curved face parts R1, R2. By means of being provided with such curved face parts R1, R2, the area of the magnetic flux passing through the respective connecting portions is enlarged and the rotational driving characteristics are enhanced.

Further, in the embodiment of the present invention, the winding layers of at least the inner half of the respective winding layers of the coil winding 24 (from the first layer to the fourth layer in the present embodiment) are held so as to be interposed between the opposed faces in the radial direction of the arc shaped core segment 12 and the teeth shaped magnetism collecting part 13b as shown in FIGS. 5(a) and 5(b). The last layer (the fourth layer in the present embodiment) of the inner side of the coil winding 24 is respectively disposed at both end positions 13c of the teeth shaped magnetism collecting part 13b in the circumferential direction. Therefore, the tip end portions of both end positions 13c in the circumferential direction of the teeth shaped magnetism collecting part 13b are formed to protrude so as to form an acute angle shape which is not a curved part.

Accordingly, the last layer (the fourth layer in the present embodiment) of the inner side of the coil winding 24 is satisfactorily held by the tip end edge parts of both circumferential end positions 13c of the teeth shaped magnetism collecting part 13b and thus loose winding for the coil winding 24 is prevented.

In the embodiment of the present invention described above, although the number of turns of the even layer of the respective winding layers of the coil winding 24 is one turn more (“N” turns with respect to “N−1” turns) than that of the odd layer, the tip end edge parts of both the circumferential end positions 13c of the teeth shaped magnetism collecting part 13b are formed so as to engage with the even layer of the respective winding layers of the coil winding 24. Therefore, the coil winding 24 is surely held by the teeth shaped magnetism collecting part 13b.

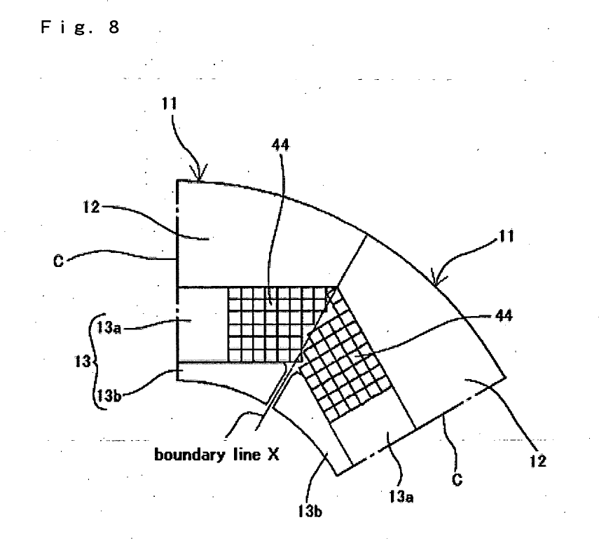

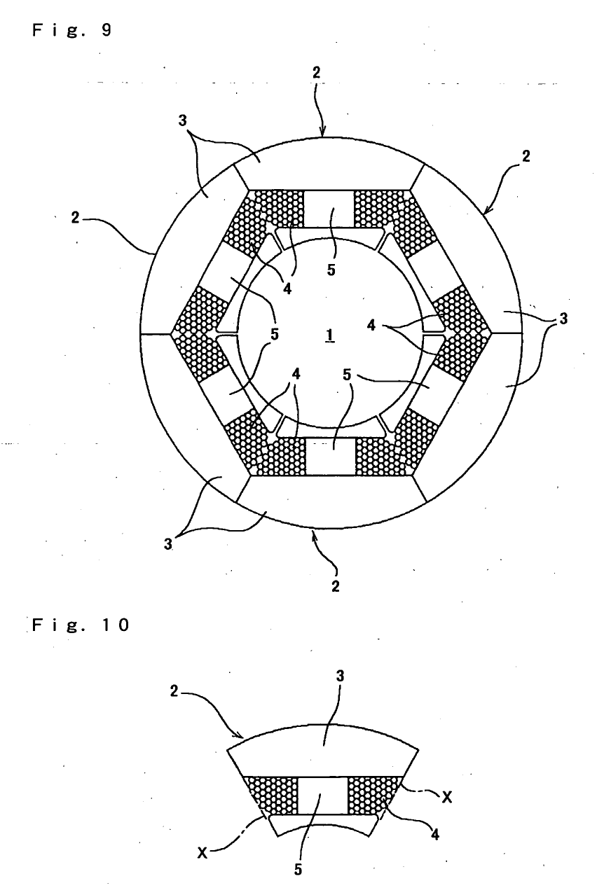

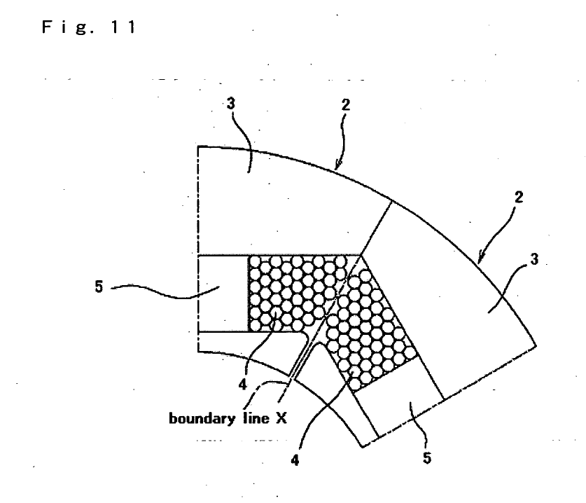

Armatures in accordance with another embodiment of the present invention shown in FIGS. 7 and 8, where the constituent elements corresponding to the above-mentioned embodiments are indicated by the same notational symbol, are constituted in such a manner that a coil winding 34 uses a hexagonal coil wire in a cross sectional shape (see FIG. 7) and that a coil winding 44 uses a rectangular coil wire in a cross sectional shape (see FIG. 8). According to the embodiments described above, the coil winding 34 and the coil winding 44 are formed to be wound thickly in comparison with using a coil wire in the circular cross sectional shape. Thereby, the space factor of the coil winding is improved and loose winding for the coil winding is prevented.

The present invention has been described in detail using the embodiments, but the present invention is not limited to the embodiments described above and many modifications can be made without departing from the present invention.

For example, in the embodiment described above, the winding configuration of the coil winding 14 is formed into two types, but three types or more winding configurations may be adopted.

Further, in the embodiment described above, the core configuration of each divided core is constituted in such a manner that the inner peripheral face of the arc-shaped core segment 12 is formed into one simple flat face, but the inner peripheral face of the arc-shaped core segment 12 may be formed to have a concaved face toward the outer side to increase coil winding space.

Furthermore, in the embodiment described above, the abutting surfaces 12a formed on both end faces in the circumferential direction of the arc-shaped core segment 12 are formed to be a simple flat face extending radially. However, a triangular projection may be formed on the simple flat face of one of the abutting surfaces 12a and a triangular concave portion may be formed on the flat face of the other abutting surface 12a so as to fit to the triangular projection. When the triangular projection is formed on one of the abutting surfaces 12a and the triangular concave portion is formed on the other abutting surface 12a, the respective divided cores can be easily positioned and assembled.

Furthermore, in the embodiment described above, the respective divided cores are formed so as to be completely separated from each other in the circumferential direction. However, the present invention is not limited to the embodiment of the divided cores of the completely separated type. For example, the present invention can be applied to a core assembly which is capable of being developed via a small connecting portion that connects the respective divided cores to each other in order to enlarge the respective spaces between the respective salient poles.

Further, the present invention can be also applied to another core assembly which can be separated inside and outside in a radial direction. In this case, respective rib-shaped arm parts constituting the core assembly are inserted into respective coil windings which are formed beforehand, and then fitted with a ring-shaped core part forming the outer peripheral core of the core assembly.

In addition, the present invention is not limited to the embodiment of the armature of the inner rotor type motor. For example, the present invention can be also applied to an armature of an outer rotor type motor. Moreover, the present invention is not limited to a motor and can be also applied to other electric rotating machines such as an electric generator.

The armature of an electric rotating machine according to the present invention described above can be widely employed in various electric rotating machines such as a motor and a generator.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An armature of an electric rotating machine comprising:
an armature core including plural divided cores arranged in a circumferential direction;
a salient pole provided in each of the plural divided cores;
a coil winding wound around each salient pole;
a convex winding configuration of the coil winding formed so as to project on an adjacent salient pole side over a boundary line between adjacent divided cores; and
a concave winding configuration of the coil winding formed to be hollow from the boundary line so as not to interfere with the convex winding configuration.

2. The armature for an electric rotating machine according to claim 1, wherein the plural divided cores are formed in a separated structure such that the plural divided cores are divided in the circumferential direction by each salient pole.

3. The armature for an electric rotating machine according to claim 1, further comprising a laminated core which is formed of magnetic plates laminated in a thickness direction to form the plural divided cores, wherein the convex winding configuration is projected over the boundary line which passes through abutting surfaces of the plural divided cores.

4. The armature for an electric rotating machine according to claim 3, further comprising two types of winding configurations of the coil winding which are alternately different from each other for every adjacent divided core in the circumferential direction.

5. The armature for an electric rotating machine according to claim 4, wherein one of the two types of winding configurations of the coil winding is formed such that the convex winding configuration of the coil winding is on an inner side and the concave winding configuration is on an outer side and the other of the two types of winding configurations of the coil winding is formed such that the convex winding configuration of the coil winding is on the outer side and the concave winding configuration is on the inner side.

6. The armature for an electric rotating machine according to claim 5, wherein each coil winding is set to have a same number of turns for each of the plural divided cores.

7. The armature for an electric rotating machine according to claim 5, wherein a number of turns of the coil winding is alternately set to have a different number of turns for every adjacent divided core.

8. The armature for an electric rotating machine according to claim 1, wherein the boundary line extends to both circumferential end positions which are respectively located at an equal angle from a center line of the salient pole on both sides in the circumferential direction, and the convex winding configuration projects on the adjacent divided core side over the boundary line and the concave winding configuration is hollow from the boundary line so as not to interfere with the convex winding configuration.

9. An electric rotating machine comprising:
an armature core including plural divided cores arranged in a circumferential direction;
a salient pole provided in each of the plural divided cores;
a coil winding wound around each salient pole;
a convex winding configuration of the coil winding formed so as to project on an adjacent salient pole side over a boundary line between the plural divided cores; and
a concave winding configuration of the coil winding formed to be hollow from the boundary line so as not to interfere with the convex winding configuration.

10. The electric rotating machine according to claim 9, further comprising a boundary line located between the plural divided cores which are adjacent to each other in a circumferential direction and extends to both circumferential end positions which are respectively located at an equal angle from a center line of the salient pole on both sides in the circumferential direction, wherein the convex winding configuration projects on the adjacent divided core side over the boundary line and the concave winding configuration is hollow from the boundary line so as not to interfere with the convex winding configuration.

11. The electric rotating machine according to claim 9, further comprising two types of winding configurations of the coil winding which are alternately different from each other for every adjacent divided core in the circumferential direction.

12. The electric rotating machine according to claim 11, wherein one of the two types of winding configurations of the coil winding is formed such that the convex winding configuration of the coil winding is on the inner peripheral side and the concave winding configuration is on the outer peripheral side and the other of the two types of winding configurations of the coil winding is formed such that the convex winding configuration of the coil winding is on the outer peripheral side and the concave winding configuration is on the inner peripheral side.

13. The electric rotating machine according to claim 12, wherein the coil windings are set to have a same number of turns for each of the plural divided cores.

14. The electric rotating machine according to claim 10, wherein a number of turns of the coil winding is alternately set to have a different number of turns for every adjacent divided core.

15. A manufacturing method for an armature of an electric rotating machine comprising:
providing an armature core having plural divided cores with a salient pole for each of the plural divided cores;
winding a coil wire around the salient pole of the plural divided core so as to form a convex winding configuration which is formed to project over a boundary line and to form a concave winding configuration which is formed to be hollow from the boundary line; and
winding a coil wire around the salient pole of adjacent divided cores so as to form a concave winding configuration which is formed to be hollow from the boundary line so as not to interfere with the convex winding configuration of the plural divided core and to form a convex winding configuration which is formed to project form the boundary line so as not to interfere with the concaved winding configuration of the plural divided core.

16. The manufacturing method according to claim 15, further comprising forming the plural divided cores in a separate structure such that the plural divided cores are divided in a circumferential direction by each salient pole.

17. The manufacturing method according to claim 15, further comprising providing a laminated core formed of magnetic plates laminated in a thickness direction to form the plural divided cores, wherein the convex winding configuration is projected over the boundary line which passes through abutting surfaces of the plural divided cores.

18. The manufacturing method according to claim 17, further comprising incorporating two types of winding configurations of the coil winding which are alternately different from each other for every adjacent divided core in a circumferential direction.

19. The manufacturing method according to claim 18, further comprising incorporating one of the types of winding configurations of the winding coil formed such that the convex winding configuration of the coil winding is on an inner side and the concave winding configuration is on an outer side and the other of the two types of winding configurations of the coil winding is formed such that the convex winding configuration of the coil winding is on the outer side and the concave winding configuration is on the inner side.

20. The manufacturing method according to claim 19, further comprising setting the coil winding to have a same number of turns for each of the plural divided cores.
